(19) United States
(12) Patent Application Publication
(10) Pub. No.: US 2004/0037554 A1
(43) Pub. Date: Feb. 26, 2004

(54) Non-coherent fiber optic apparatus and imaging method

(76) Inventors: Gary William Ferguson, Burnaby (CA); Haishan Zeng, Vancouver (CA)

Correspondence Address: Timothy M. McCarthy, Trexler, Bushnell, Giangiorgi, Blackstone & Marr, 36th Fl., 105 W. Adams St., Chicago, IL, 60603, US

(21) Appl. No.: 10/226,406

(22) Filed: Aug. 23, 2002

(51) Int. Cl. H04B 10/00; H04B 10/12

(52) U.S. Cl. 398/28; 398/25; 356/73.1

(57) ABSTRACT

The present invention is a non-coherent optical fiber apparatus that may be used for imaging. Methods are described to produce geometric mapping data for an optical fiber apparatus. Images may be transmitted, reconstructed (using mapping data for the apparatus) and displayed. In addition, one or more fiber characteristics may be measured and used in conjunction with mapping data to further improve or correct the geometric, photometric or spectral content of images. The apparatus data described may be provided, by a manufacturer, for example, in raw form, or this data may be may be provided in a manner that is more user transparent, such as incorporating it into various image processing algorithms.

### BACKGROUND OF THE INVENTION

In the field of fiber optics, rigid or flexible light transmitting fibers made of glass, plastic, polymers, or fluid-filled tubes etc. have many applications. Optical fibers can be further tailored to an application by selecting materials based on their mechanical properties such as size, shape, and flexibility and optical characteristics such as refractive index and transmission properties. Appropriately designed, optical fibers allow light to be transmitted over useful distances. Often two or more optical fibers are bundled, grouped or otherwise placed in close association to form a fiber optic bundle or conduit. Some applications of fiber optics include: delivering light to relatively inaccessible areas, such as instrument panels and body cavities, guiding laser light for medical procedures and carrying communications data. Further, in certain configurations, such as a coherent bundle, fiber optics may be used to transmit images, which is a subject of the present invention.

In the case of fiber optic endoscopes, tens of thousands of fibers may be utilized in a single device. Accordingly, within a single apparatus, for example, one fiber optic conduit may be used to deliver blue light (e.g. into the lungs) while a second fiber optic bundle may be used to return an image (e.g. an auto-fluorescence image of lung for diagnostic assessment).

When used to transmit images, existing methods place strict requirements on the geometric relationship between individual fibers at opposite ends of a fiber optic apparatus. This geometric relationship is established and maintained during manufacturing. Typically, a core bundle of larger fibers are assembled, heated, and these fibers or cores are drawn out together, thus maintaining the side-by-side relationship of the fibers. Subsequently, both ends of these fiber bundles are cemented, fused, secured by an end sleeve or otherwise fixed.

This manufacturing process places certain limitations on the characteristics of fibers which may be used in the device. Similarly, when a substantial number of fibers are involved, imperfections in a sub-set of fibers may reduce device yield and thus increase manufacturing costs. In addition, for some applications, it may be advantageous to be able to select or mix fibers with desired properties.

Some of these manufacturing methods, concerns and limitations are further discussed in:

U.S. Pat. No. 4,011,007 to Phaneuf entitled “Optical fiber bundle image conduit”;

U.S. Pat. No. 4,389,089, to Strack, entitled “Flexible fiber optical conduit and method of making”;

U.S. Pat. No. 6,085,011 to Klausmann entitled “Metal fiber end sleeve for a flexible fiber optic light guide and method for producing same”;

U.S. Pat. No. 4,812,400 to Washizuka entitled “Optical fiber assembly for an endoscope”;

U.S. Pat. No. 5,944,867 to Chesnoy, entitled “Method of manufacturing a multi-core optical fiber”;

U.S. Pat. No. 4,461,841 to Harada, entitled “Acid-soluble glass composition for making flexible fiber optic bundle”.

To provide fibers with comparable diameters and properties, rods or cores of larger glass fibers are typically heated and are drawn as a unit to the desired cross-sectional size. Similarly, individual larger cores may be fused together and the larger assemblies drawn out, together. This process is described for example in U.S. Pat. No. 4,389,089 to Strack, entitled “Flexible fiber optical conduit and method of making” and in U.S. Pat. No. 4,011,007 to Phaneuf entitled “Optical fiber bundle image conduit”.

Hicks in U.S. Pat. No. 3,004,368, issued Oct. 17, 1961, entitled “Manufacture of fiber optical devices”, teaches: “In order to obtain an accurate reproduction of an image which is transferred by a device of the above character, it is essential that the individual light-conducting fibers be arranged in identical geometric patterns at the opposite ends of the device so that each part of an image at the object end of the device will be reproduced at the image end thereof in its true location.”

Twenty three years later, these same limitations were echoed by Harada in U.S. Pat. No. 4,461,841, issued Jul. 24, 1984, entitled “Acid-soluble glass composition for making flexible fiber optic bundle”, in which he teaches: “When the fiber optic bundle is used as an image-transmitting device, it is essential that the individual optical fibers be arranged in identical geometric patterns at the opposite ends of the bundle so that each part of an image at the object end of the bundle will be reproduced at the image end thereof in the same location.”

More recently still, U.S. Pat. No. 6,205,275, to Melville, entitled “Fiber-optic image transfer assembly and method of using” among other things discusses fiber optic tapers used to magnify or reduce images using coherent configurations.

U.S. Pat. No. 4,011,007 to Phaneuf entitled “Optical fiber bundle image conduit” expresses this in terms of manufacture, stating “Accordingly, after drawing the bundle to its final dimension, opposite ends of the drawn bundle may be plotted to enclose and maintain the geometric patterning of the individual fiber ends of the conduit.”

More recently, in respect to multi-core optical fibers, Chesnoy in U.S. Pat. No. 5,944,867 entitled “Method of manufacturing multi-core optical fiber”, says “One of the main requirements making multi-core optical fibers is that the cores must be positioned accurately relative to one another. Such accurate positioning makes it possible to effect reliable connections, and to avoid interference between signals conveyed by the various cores (crosstalk).” U.S. Pat. No. 5,222,180, to Kuder, entitled “Polymer optical fibre bundle and method of making same” discusses alternative means of configuring fiber optic devices with close-packed geometry which include fibers that are not substantially oval shaped.

Substantial efforts have been applied to develop methods to maintain the required fiber geometry for imaging, such as fused ends or application of an end sleeve. U.S. Pat. No. 6,085,011 to Klausmann entitled “Metal Fiber end sleeve for a flexible fiber optic light guide and method for producing same”, discusses final assembly and application of an end sleeve to maintain fiber alignment. In addition, Klausmann describes aspects of the process as potentially being very time consuming, exacting and indicates that sometimes complete fiber alignment is difficult or not possible to achieve.

U.S. Pat. No. 5,717,806, to Pileski, entitled “Bifurcated randomized fiber bundle light cable for directing light from multiple sources to a single light output”; and U.S. Pat. No. 6,418,257, to Nash, entitled, “UVC liquid light guide” discuss various aspects of fiber optical apparatus.

U.S. Pat. No. 6,388,742 to Duckett, entitled “Methods and apparatus for evaluating the performance characteristics of endoscopes” further describes means to test an endoscope.

Means and methods cited above may be exploited to advantage for the present invention and are therefore included by reference herein.

There remains a need for a fiber optic imaging apparatus which better meets the optical, physical, mechanical and manufacturing requirements, such as higher yield and/or reduced cost. It is therefore an object of the present invention to provide a fiber optic apparatus for imaging that does not require that the geometric relationship of fibers at respective ends, correspond. Another object of the present invention to allow a wider range of materials and fibers that may be selected to form an imaging bundle that may be used for imaging. It is a further object of the present invention to provide a fiber optical apparatus that may be manufactured more easily, with higher yield, at lower cost or otherwise provide advantages. It is a further object of the present invention to provide a means to improve or correct for geometric, photometric or spectral content of images.

### SUMMARY OF THE INVENTION

The present invention is a fiber optic imaging apparatus that does not require that the geometric relationship of fibers at respective ends, correspond. This relaxed constraint means that cheaper fibers or fibers with desired characteristics, fibers of various shapes, or bundles of fibers or organizations with mixtures of fibers with diverse properties may be combined to form a new apparatus. Therefore, the present invention allows a wider range of fiber selection to better meet desired optical and/or physical characteristics such as spectral response, transmission efficiency, flexibility, size, weight, etc. for the optical imaging apparatus.

As used herein, fiber characteristic means the physical and optical properties of optical fibers or optical fiber bundles including their size, shape, flexibility, diameter, area, tapering, bandwidth, bend radius, material composition, chromatic dispersion, cladding, cleave, coating, concentricity, core, core eccentricity, attenuation, spectral attenuation, graded index, refractive index, length, insertion loss, tensile strength, jacketing material, numerical aperture, or any other parameter that may be measured and exploited to advantage. When a plurality of fibers are considered, field of view, image quality, distortion, depth of field etc. represent additional useful characteristics.

Please note that another name for “fluid-filled tube” or “fluid-filled light guide” is “liquid light guide”.

A method of developing geometric mapping data for a fiber optic apparatus during or subsequent to manufacture is described. A method of using a fiber optic apparatus with geometric mapping data for imaging is also described. In addition, a method of measuring one or more optical fiber characteristics is described along with a method of utilizing measured fiber characteristic to further improve or correct the geometric, photometric or spectral content of images. Such data may be recorded and may be provided in electronic or other useful format or this data may be made transparent to the user by incorporating it into image processing algorithms, and supplying these.

### BRIEF DESCRIPTION OF DRAWINGS

The foregoing and other objects, features, and advantages of the invention will be apparent from the following descriptions of preferred embodiments and drawing illustrating principals of the invention and its use.

In the accompanying drawings:

FIG. 1 (Prior art) shows the existing limitations of fiber geometry and provisions necessary to use a fiber optic bundle for imaging.

FIG. 2 shows the present invention as used to transmit an image or other information before additional methods are applied.

FIG. 3 shows a method to discern the geometric relationship between fibers at opposite ends of an optical fiber bundle.

FIG. 4 illustrates a method to further automate the recording of fiber mapping data and fiber characteristics.

FIG. 5a further illustrates the present invention

FIG. 5b further illustrates the process of developing and recording mapping data and fiber characteristic data.

FIG. 5c illustrates the application of fiber mapping and fiber characteristics for image reconstruction and processing.

FIG. 6 illustrates a more complex fiber optic apparatus

### DETAILED DESCRIPTIONS OF THE PREFERRED EMBODIMENTS

While the invention may be susceptible to embodiments in different forms, there is shown in the drawings, and herein will be described in detail, specific embodiments with the understanding that the present disclosure is to be considered an exemplification of the principles of the invention, and is not intended to limit the invention to that as illustrated and described herein.

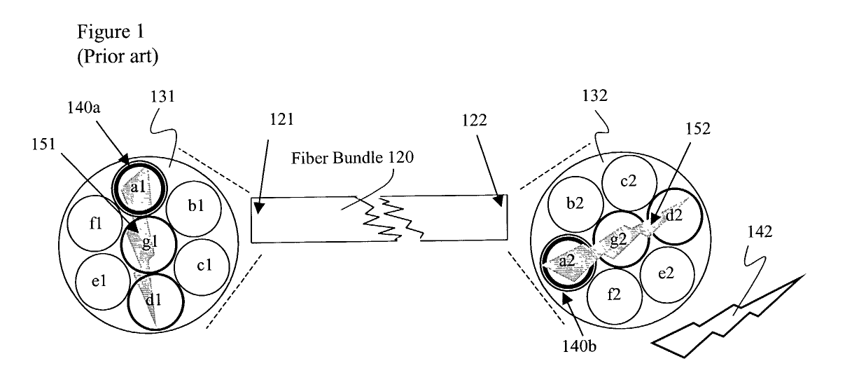

FIG. 1 (Prior art) illustrates a fiber bundle 120 having a first (reference) end 121 and a second end 122 which are further shown in expanded views 131,132, respectively. The fiber bundle illustrated has seven fibers indicated as a-g, further designated as a1-g1 at the first end and opposing ends of these fibers designated a2-g2 at the second end. Although there may be some axial rotation of the fiber bundle 120, individual fibers a1 -g1, at the first end 121, seen in expanded view 131, maintain their geometric position, that is their side-by side relationship and emerge at the second end 122 at the same relative geometric position. Often, as a step in the manufacturing process for fiber optic bundles, fibers are drawn together, preserving this geometry. Then the first and second ends are fitted with an end sleeve or these ends are cemented, fused or otherwise, their geometries are fixed. Subsequently, once the ends are fixed fibers may be allowed to flex and move independently within the conduit of the fiber bundle, as desired.

Geometric position and axial rotation are further indicated and may be seen by comparing relative geometric position of all fibers in respect to a reference point, at each end. Reference point means a location, mark or marks that may be established and used to identify the geometric position of fibers at the end of an optical fiber apparatus, such as a selected fiber, scribe, connector notch, protrusion, indentation, magnetic ink spot, or any other indicator that can be exploited, accordingly. In this case fiber a1 (further designated 140a) at the first end serves as a reference point and the opposite end of this fiber, a2, designated 140b serves as a reference point for the second end. Moving from reference point 140a at the first end, fibers b1, c1, d1, e1, f1 appear in clockwise order, as illustrated, with fiber g1 (at the middle). Similarly, moving from the corresponding reference point 140b at the second end, preservation of the geometric position is illustrated with fibers appearing clockwise, as indicated, b2, c2, d2, e2, f2, with g2 in the middle. Such a geometric configuration allows fiber optic bundle to transmit an image (or other information that relies upon geometric position) and allows that information to be substantially recovered, or viewed.

To illustrate use of fiber bundle 120, for imaging, object 142 is positioned at the second end allowing an object image 152, to be substantially captured by fibers a2,g2,d2 as indicated in expanded view 132. The object image 152 is transmitted by these fibers and emerges as object image 151, in the expanded view 131, at the first end 121 of the fiber bundle 120. The described geometry shows how information content, such as object image 152, is transmitted and recovered. Clearly, this level of image detail will not be preserved in the relatively large fibers diagramed, however, the shape and position of the object are intended to illustrate the principals of image content and orientation. Alternatively, each of the fibers could be considered to be a bundle of smaller fibers in a coherent arrangement so as to better approximate the diagram. For consistency these principals will be used in subsequent figures.

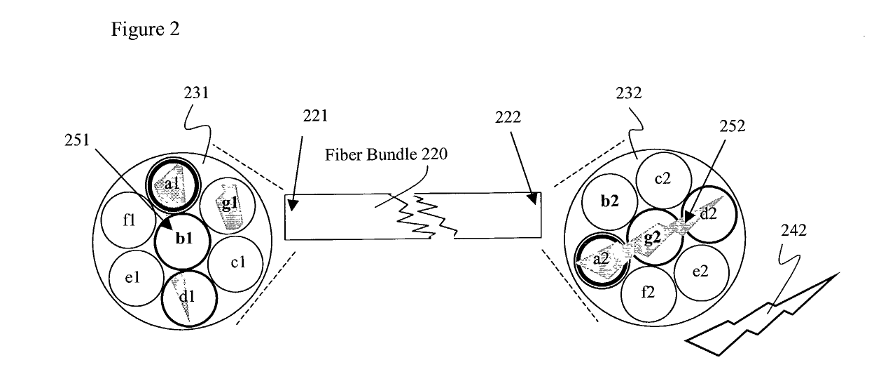

FIG. 2 illustrates a fiber optic apparatus of the present invention with a fiber bundle 220, having a first (reference) end 221 and a second end 222 which are as also shown in expanded views 231,232, respectively. Although there may be some axial rotation of the fiber bundle 220, individual fibers indicated by a1-g1 at the first end 231, do not necessarily maintain their geometric position at the second end 232 as indicated by fibers a2-g2. Note in particular that fibers designated as b2 and g2 at the second end (as seen in expanded view 232) are displaced relative to their geometric position, (illustrated as b1 and g1) relative to first end expanded view 231. To better illustrate the properties of this particular fiber bundle 220, an image 252 of object 242 at the second end of the fiber bundle 220, as diagramed, is seen to be substantially captured by fibers a2,g2,d2 in second end expanded view 232. The object image 252 is transmitted by these fibers and is seen to emerge as object image 251 at the first end of the fiber bundle 220 in fibers a1,g1,d1. However, since geometric position of the fibers in fiber bundle 220 are not preserved between the first end 221 and the second end 222, the image information is degraded. Additional figures will describe methods to measure and record geometric mapping data for an optical fiber apparatus to use such a non-coherent bundle for imaging.

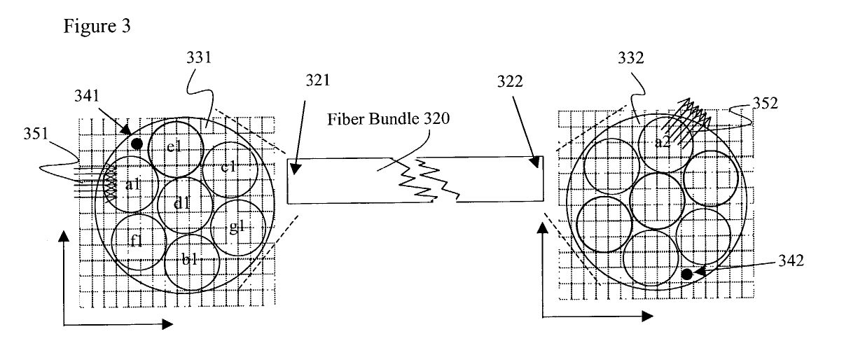

FIG. 3 illustrates a fiber optic apparatus of the present invention with fiber bundle 320, having a first (reference) end 321 and a second end 322 which are shown in expanded views 331,332, respectively. Electromagnetic radiation 351 is directed into fiber (a1) at the first end. Various methods of directing light into fibers are known, some of which employ lenses, light modulators, optical couplers, micro-mirror devices etc. U.S. Pat. No. 6,388,742 discusses testing endoscopes using a plurality of light sources to test field of view, image quality distortion, depth of field and angle of view. U.S. Pat. No. 6,434,302, to Fidric, entitled “Optical couplers for multimode fibers”, U.S. Pat. No. 6,016,376 to Ghaemi, entitled “Tapered coherent fiber bundle imaging device for near-field optical microscopy” and U.S. Pat. No. 5,864,644 to DiGiovanni, entitled “Tapered fiber bundles for coupling light into and out of cladding pumped fiber devices”. The prior art discussed in association with FIG. 3 addresses optical coupling and other aspect of optical apparatus and is therefore included herein by reference.

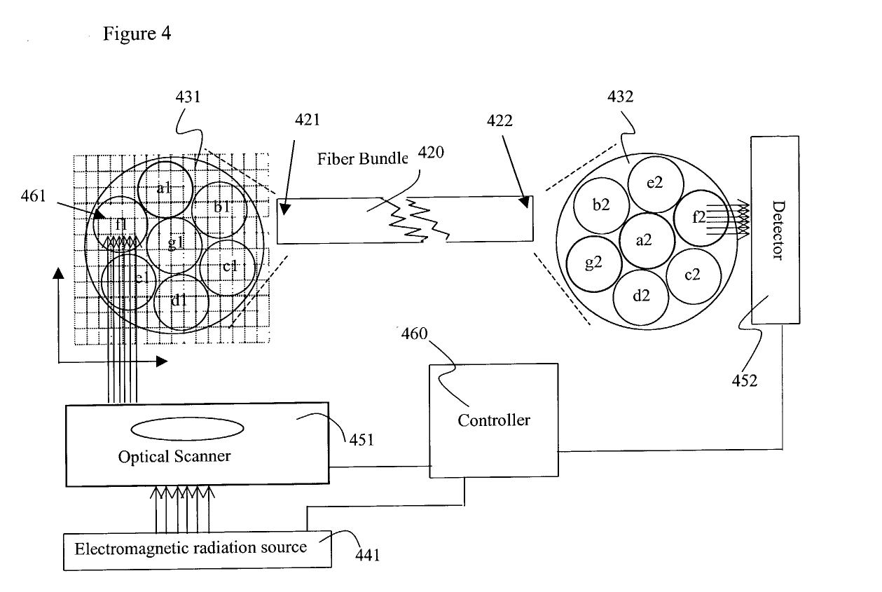

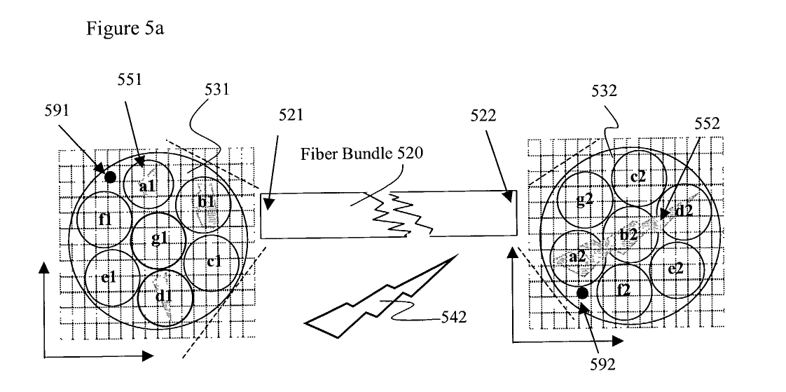

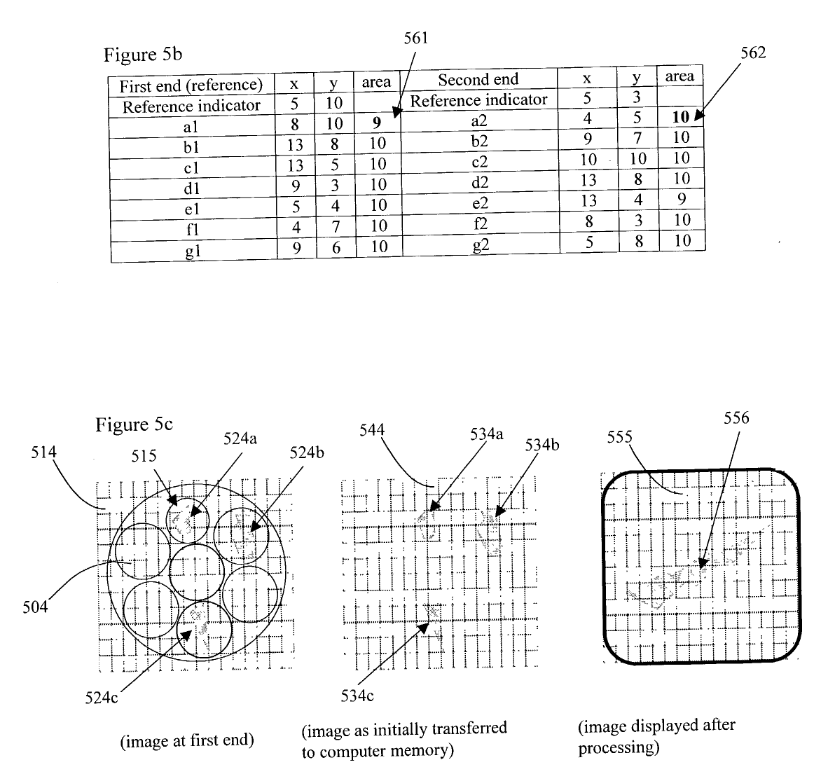

The fiber (a1) may be identified in any effective or convenient manner such as by designating it a color, letter, number, scribe, x-y location, geometric coordinate etc. In this instance, for example, it may be identified by its geometric position relative to a reference point, in this instance, mark 341. Accordingly, electromagnetic radiation is transmitted down the fiber and emerges as 352 at the opposite end of the fiber as labeled (a2) in the second end expanded view 332. As necessary, electromagnetic radiation may be adjusted at the first end until it is seen to emerge from substantially a single fiber at the second end. The geometric position of the fiber at the second end is now recorded, in this instance, using mark 342 as a reference point. By proceeding in this manner geometric mapping data may be recorded for the device. Similarly, fiber characteristics, for example, diameter, surface area, intensity or spectral properties of emerging light, for individual or groups of fibers may be measured and recorded. A more automated method of measuring and recording the geometric mapping data will be described in association with FIG. 4 with a geometric mapping with device characteristics further described, applied and illustrated in association with FIG. 5a,b,c.

FIG. 4 illustrates a fiber bundle 420, of the present invention, having a first (reference) end 421 and a second end 422, shown in expanded views 431, 432, respectively. As indicated, in addition to some rotation of the fiber bundle 420, individual fibers a2-g2 at the second end 422 (seen in expanded view 432), do not necessarily correspond geometrically with their position illustrated as a1-g1 in first end expanded view 431. As illustrated, under guidance of a controller, electromagnetic radiation from source 441 is focused and scanned 451 onto desired fibers (or groups of fibers) at the first end of the fiber bundle. Fiber f1 (461) in expanded view 431, as illustrated, receives radiation. That radiation is transmitted down the fiber and emerges from the opposite end of the fiber designated as f2 in second end expanded view 432 and is detected by a detector 452, which could be for example, a CCD camera. When radiation is determined to emerge substantially from one fiber at the second end, as described in association with FIG. 3, geometric position may be recorded in an appropriate manner. The method and configuration of FIG. 4 allows mapping data to be gathered, recorded or otherwise stored, in an automated manner. The same detector 452 may be used or additional detectors (not shown) may be employed to measure fiber characteristics other than geometric position, such as fiber diameter, surface area, intensity or spectral response from the emerging radiation, etc as discussed in association with FIG. 3.

For convenience, rather than providing a detector at the first end, once the geometric location of a fiber is known, the fiber optic bundle may be reversed to allow other useful fiber characteristics to be measured for the first end.

FIG. 5a illustrates the method of fiber mapping and its application. As discussed in association with FIG. 2, here object information 552 representing object 542 is carried by the fiber bundle, in this instance substantially by fibers a2,b2,d2 at the second end 522, shown in expanded view 532. Some information content is degraded, lost or displaced as received at the first end 521, illustrated as 551 in the expanded view 531. The degradation in information content, in this instance is represented by the change in geometric position of fibers b2,g2 at the second end, relative to their position at the first (reference) end. Again, as discussed in association with previous figures, geometric position may be established relative to a reference point, in this instance mark 591 and mark 592 at respective ends of fiber bundle 520.

The x,y geometric position at the first end and second end indicated by the grid may provide, if desired, sufficient resolution to determine the position of the fiber and allow additional fiber characteristics, as defined, (e.g. area), to be measured. For example, an appropriate CCD used as a detector as described with FIGS. 3 and 4, combined with control over the wavelength(s) or intensity of the light source allows characteristics of individual fibers or groups of fibers to be measured. Various detectors and means, such as spatial light modulators, spectrometers, photometers etc. may be combined appropriately to measure desired fiber characteristics. Additional image degradation is further illustrated via the reduced area of fiber a, identified as a1 in first end expanded view 531 and further identified by legend 551. Measurement of such a fiber characteristic and application of this data will now be further described along with application of fiber characteristic data to image processing.

FIG. 5b shows the mapping data and a measured fiber characteristic for the fiber apparatus diagramed in FIG. 5a. In this example, fiber e1 has an area of 10, indicated as 561, at the first end, and area 9, indicated as 562 at the second end. Measurement of such fiber characteristics may be used to further correct, improve or otherwise be applied to advantage in processing the image. In this instance the image data transmitted in this fiber is shown smaller and is amplified (shown larger) during image process as will be further described in association with FIG. 5c.

Geometric data mapping and measurement of desired fiber characteristics may be recorded and stored in various ways. A user could perform these functions or more typically, a manufacturer would gather this data and provide the optical fiber apparatus with this support data, providing it in a useful form such as on a computer disk or making it available in electronic form that could be downloaded from the internet, for example. Similarly, this data may be abstracted in the form of image processing algorithms where geometric and any characteristic data is incorporated in a more transparent manner.

As describe in U.S. Pat. No. 6,388,742, complex fiber imaging apparatus may be assessed for performance. The present invention, using geometric and fiber characteristic data would allow a given device to be programmed to meet or match a ‘bench-mark’ or reference device. Such matching could be performed with the aid of computers and various detectors and light sources. The result would be a batch of devices with substantially similar characteristics. Medical, industrial and other fields of use would benefit accordingly. Tapered fiber bundles provide an example of devices, which are currently relatively complex and expensive to manufacture.

FIG. 5c shows a camera sensor (514) capturing image information having principal components 524a, 524b and 524c from one end 504 of an optical fiber apparatus of the present invention. Raw image data from camera sensor 514 is transferred to computer memory 544 and the image data is represented in this domain by components 534a, 534b and 534c. Some data loss through fiber ‘a’ (shown smaller in FIG. 5a, marked 515) is further indicated in the capture of the object image component 534a-transmission characteristics for this fiber, having been measured and represented in the mapping data as described in association with FIG. 5b. Raw image data in computer memory 544 is now processed using mapping and characteristic data for the apparatus. Display of the processed image data 556 is shown on computer display 555. As illustrated, image component 534a is corrected based on measured fiber characteristics stored in conjunction with the geometric mapping data. Measuring such fiber characteristics and applying them appropriately with mapping data allows further geometric, photometric or spectral processing to be applied to images. The image is reconstructed from the fiber geometry stored in the mapping data. Finally, as illustrated the reconstructed image data is rotated, in this instance to recover the orientation of the original object 542 of FIG. 5a. Additionally, fiber characteristics may be further applied, for example to correct for photometric loss or spectral changes. Accordingly, substantial portions of the image could be color corrected for display.

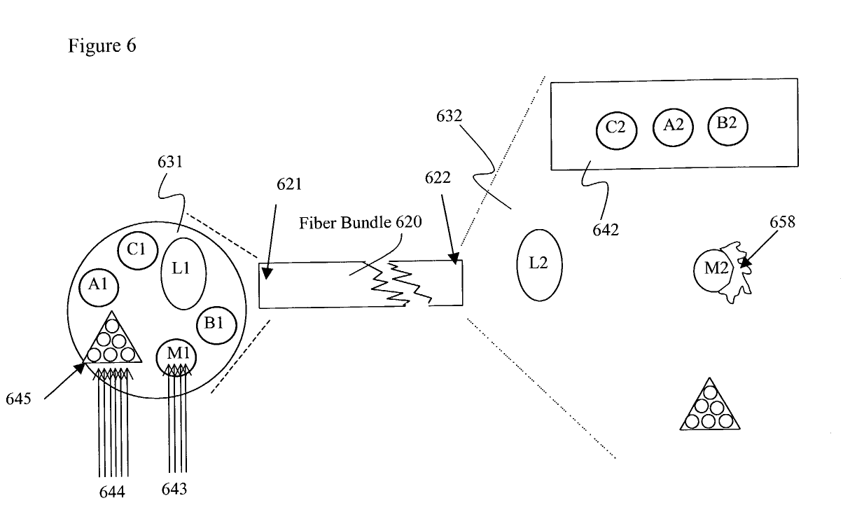

FIG. 6 illustrates a fiber optic apparatus 620 of the present invention having a first end 621 seen in first end expanded view 631, has various components which are separated at the second end 622, as shown in second end expanded view 632. In this instance two separate sources of electromagnetic radiation, 643, 644 are used during the mapping process as previously described is association with FIGS. 3,4,5. A non-round fiber bundle 645 has all of its fibers illuminated simultaneously during mapping. Fiber L1 as illustrated represents a fluid filled light guide which could be used, for example, to illuminate the instrument panel of a measurement device. Fibers A1,B1,C1 at the first end, emerge at the second end as A2,B2,C2. The fibers are separated and positioned so as to read a DNA micro-array from microscope slide 642. Fiber designated M1 at the first end emerges and has its second end M2 and that end is further shown coated with a fluorescent tagged monoclonal antibody thus forming a bio-probe for a specific protein. As previously described desired fiber characteristics and geometric information are stored for the apparatus and may be used accordingly.

While a preferred embodiment of the present invention is shown and described, it is envisioned that those skilled in the art may devise various modifications of the present invention without departing from the spirit and scope of the appended claims.

We claim:

1. A fiber optic mapping apparatus comprising
a plurality of optic fibers,
each of said fibers having a first end and a second end,
wherein said fibers have positions at said first end, and positions at said second end, and
wherein said position of at least one of said fibers at said first end is known and said position of said at least one of said fibers at said second end is unknown,
means for transmitting electromagnetic radiation into said first end of said at least one of said fibers,
means for detecting said electromagnetic radiation at said second end of said at least one of said fibers,
means for recording said position of said at least one of said fibers at said second end.

2. The apparatus of claim 1, further comprising means for providing said recorded position of said at least one of said fibers at said second end.

3. The apparatus of claim 1, further comprising at least one additional fiber optic bundle, comprising at least one optic fiber, associated with the said fiber optic bundle.

4. The apparatus of claim 1, further comprising means for measuring at least one characteristic of said at least one of said fibers at said first end.

5. The apparatus of claim 4, wherein said means for recording further records the measurement of said at least one characteristic.

6. The apparatus of claim 5, further comprising means for providing said measurement of said at least one characteristic.

7. The apparatus of claim 4, further comprising means for selecting at least one of said fibers based on said measured at least one characteristic.

8. The apparatus of claim 4, further comprising means for measuring at least one characteristic of said at least one of said fibers at said second end.

9. The apparatus of claim 8, wherein said means for recording further records the measurement of said at least one characteristic of said at least one of said fibers.

10. The apparatus of claim 9, further comprising means for providing said measurement of said at least one characteristic.

11. The apparatus of claim 8, further comprising means for selecting at least one of said fibers based on said measured at least one characteristic.

12. The apparatus of claim 1, wherein said plurality of optic fibers is grouped in a tapered bundle.

13. The apparatus of claim 1, further comprising means for identifying said at least one of said fibers at said first end based on at least one of the following: color, letter, number, scribe, x-y location, geometric coordinate, axial coordinate, Cartesian coordinate, position relative to a reference point.

14. An apparatus for transmitting image information, comprising
a plurality of optic fibers forming a fiber optic bundle having a first end and a second end,
wherein said fibers have positions at said first end, and positions at said second end, and
wherein said position of said at least one of said fibers at said first end is known and said position of said at least one of said fibers at said second end is unknown,
means for identifying said at least one of said fibers at said first end,
means for detecting said position of said at least one of said fibers at said second end,
means for recording said position of said at least one of said fibers at said second end,
means for transmitting information encoded as optical signals into said first end of said fibers,
means for receiving said optical signals from said second end of said fibers, and
means for using said recorded position of said at least one of said fibers at said second end to decode said received optical signals into said transmitted information.

15. The apparatus of claim 14, further comprising means for providing said recorded position of said at least one of said fibers at said second end.

16. The apparatus of claim 14, further comprising at least one additional fiber optic bundle, comprising at least one optic fiber, associated with the said fiber optic bundle.

17. The apparatus of claim 14, further comprising means for measuring at least one characteristic of said at least one of said fibers at said first end.

18. The apparatus of claim 17, further comprising means for recording the said at least one characteristic of said at least one of said fibers.

19. The apparatus of claim 18, further comprising means for providing the said at least one characteristic.

20. The apparatus of claim 17, further comprising means for selecting fibers based on the said at least one characteristic.

21. The apparatus of claim 14, further comprising means for measuring at least one characteristic of said at least one of said fibers at said second end.

22. The apparatus of claim 21, further comprising means for recording said at least one characteristic of said at least one of said fibers.

23. The apparatus of claim 22, further comprising means for providing said at least one characteristic.

24. The apparatus of claim 21, further comprising means for selecting fibers based on said at least one characteristic.

25. The apparatus of claim 14, wherein said fiber optic bundle is tapered.

26. The apparatus of claim 14, wherein said means for identifying is based on at least one of the following: color, letter, number, scribe, x-y location, geometric coordinate, axial coordinate, Cartesian coordinate, position relative to a reference point.

27. An apparatus for transmitting information, comprising
a plurality of optic fibers forming a fiber optic bundle having a first end and a second end,
wherein said fibers have a first end position and a second end position,
means for mapping said first end position,
means for mapping said second end positions,
means for measuring a characteristic of each of said fibers,
means for transmitting image information comprising optical signals into said second end,
means for receiving said optical signals at said first end,
means for using said mapped first end positions and said second end positions to decode said received optical signals, and
means for improving said image information by using said measured characteristic.

28. An apparatus for measuring a characteristic of optical fibers, comprising
means for identifying the geometric position of said fibers,
means for measuring at least one characteristic of each of said fibers, and
means for recording said at least one characteristic.

29. A fiber optic mapping method comprising
grouping a plurality of optic fibers to form a fiber optic bundle having a first end and a second end,
wherein said fibers have positions at said first end, and positions at said second end, and
wherein the position of at least one of said fibers at said first end is known and the position of said at least one of said fibers at said second end is unknown,
identifying said at least one of said fibers at said first end,
detecting said position of said at least one of said fibers at said second end, and
recording the position of said at least one of said fibers at said second end.

30. The method of claim 29, further comprising providing said recorded position of said at least one of said fibers at said second end.

31. The method of claim 29, wherein at least one additional fiber optic bundle, comprising at least one optic fiber, is associated with the said fiber optic bundle.

32. The method of claim 29, further comprising measuring at least one characteristic of said at least one of said fibers at said first end.

33. The method of claim 32, further comprising recording said at least one characteristic of said at least one of said fibers.

34. The method of claim 33, further comprising providing said at least one characteristic.

35. The method of claim 32, further comprising selecting at least one of said fibers based on said at least one characteristic.

36. The method of claim 29, further comprising measuring at least one characteristic of said at least one of said fibers at said second end.

37. The method of claim 36, further comprising recording said at least one characteristic of said at least one of said fibers.

38. The method of claim 37, further comprising providing said at least one characteristic.

39. The method of claim 36, further comprising selecting at least one of said fibers based on said at least one characteristic.

40. The method of claim 29, further comprising grouping said plurality of optic fibers to form a tapered fiber optic bundle.

41. The method of claim 29, further comprising identifying said at least one of said fibers at said first end based on at least one of the following: color, letter, number, scribe, x-y location, geometric coordinate, axial coordinate, Cartesian coordinate, position relative to a reference point.

42. A method of transmitting fiber optic information, comprising
grouping a plurality of optic fibers to form a fiber optic bundle having a first end and a second end,
wherein said fibers have positions at said first end, and positions at said second end, and
wherein the position of said at least one of said fibers at said first end is known and the position of said at least one of said fibers at said second end is unknown,
identifying said at least one of said fibers at said first end,
detecting said position of said at least one of said fibers at said second end,
recording said detected position of said at least one of said fibers at said second end
transmitting information encoded as optical signals into said first end of said fibers
receiving said optical signals from said second end of said fibers, and
using said recorded position of said at least one of said fibers at said second end to decode said received optical signals into said transmitted information.

43. The method of claim 42, further comprising providing said recorded position of said at least one of said fibers at said second end.

44. The method of claim 42, further comprising associating at least one additional fiber optic bundle, comprising at least one optic fiber, with the said fiber optic bundle.

45. The method of claim 42, further comprising measuring at least one characteristic of said at least one of said fibers at said first end.

46. The method of claim 45, further comprising recording said at least one characteristic of said at least one of said fibers.

47. The method of claim 46, further comprising providing said at least one characteristic.

48. The method of claim 45, further comprising selecting at least one of said fibers based on said at least one characteristic.

49. The method of claim 42, further comprising measuring at least one characteristic of said at least one of said fibers at said second end.

50. The method of claim 49, further comprising recording said at least one characteristic of said at least one of said fibers.

51. The method of claim 50, further comprising providing said at least one characteristic.

52. The method of claim 49, further comprising selecting at least one of said fibers based on said at least one characteristic.

53. The method of claim 42, further comprising grouping said plurality of optic fibers to form a tapered optic bundle.

54. The method of claim 42, further comprising identifying said at least one of said fibers at said first end based on at least one of the following: color, letter, number, scribe, x-y location, geometric coordinate, axial coordinate, Cartesian coordinate, position relative to a reference point.

55. A method of transmitting information, comprising
grouping a plurality of optic fibers to form a fiber optic bundle having a first end and a second end,
wherein said fibers have a first end position and a second end position,
mapping said first end position,
mapping said second end positions,
measuring a characteristic of each of said fibers,
transmitting image information comprising optical signals into said second end,
receiving said optical signals at said first end,
using said mapped first end positions and said second end positions to decode said received optical signals, and
improving said image information by using said measured characteristic.

56. A method of measuring a characteristic of optical fibers, comprising
identifying the geometric position of said fibers,
measuring at least one characteristic of each of said fibers, and
recording said at least one characteristic.
